(19) United States
(12) Patent Application Publication
(10) Pub. No.: US 2026/0341786 A1
(43) Pub. Date: Oct. 29, 2026

(54) DRY ION EXCHANGE MEMBRANE PRODUCTION METHOD

(71) Applicant: AGC Inc., Tokyo (JP)

(72) Inventors: Shintaro HAYABE, Tokyo (JP); Kosuke SUMIKURA, Tokyo (JP); Toshiaki SAWADA, Tokyo (JP); Ken KOMATSU, Tokyo (JP)

(73) Assignee: AGC Inc., Tokyo (JP)

(21) Appl. No.: 19/691,683

(22) Filed: May 29, 2026

Related U.S. Application Data
(63) Continuation of application No. PCT/JP2024/043090, filed on Dec. 5, 2024.

(30) Foreign Application Priority Data
Dec. 8, 2023 (JP) 2023-207544

(51) Int. Cl. H01M 10/0565

(52) U.S. Cl. CPC H01M 10/0565; H01M 2300/0025

(57) ABSTRACT

To provide a method for producing a dry ion exchange membrane with which a water electrolyzer with suppressed leakage can be produced. The dry ion exchange membrane production method of the present invention comprises drying a wet ion exchange membrane that contains a fluorinated polymer having ion exchange groups wetted with a liquid medium to remove the liquid medium thereby to obtain a dry ion exchange membrane; wherein the drying of the wet ion exchange membrane is initiated from a state where the amount of the liquid medium attached to the surface of the wet ion exchange membrane is 40 g/m² or more and 600 g/m² or less.

### TECHNICAL FIELD

The present disclosure relates to a dry ion exchange membrane production method.

### BACKGROUND ART

For batteries, electrolysis processes and ion separation processes, etc., an ion exchange membrane has been used. Patent Document 1 discloses a method in which a membrane that contains a fluorinated polymer having acid form ion exchange groups (—SO₃H groups) is dried to obtain an ion exchange membrane in a dry state that contains a fluorinated polymer having —SO₃H groups.

Such an ion exchange membrane is installed in a cell of a water electrolyzer in a state of a membrane electrode assembly having an anode, the ion exchange membrane (electrolyte membrane) and a cathode stacked in this order. To a periphery of the membrane electrode assembly, usually a gasket is attached for the purpose of suppressing leakage of the electrolytic solution such as water outside the water electrolyzer and suppressing breakage of the membrane electrode assembly.

### PRIOR ART DOCUMENTS

### Patent Documents

Patent Document 1: JP-A-2005-060516

### DISCLOSURE OF INVENTION

### Technical Problem

The present inventors have produced a membrane electrode assembly using an ion exchange membrane in a dry state as disclosed in Patent Document 1 and installed the membrane electrode assembly having a gasket attached to its periphery into a cell of a water electrolyzer, and they have found that an electrolytic solution (for example water) supplied to the cell may leak outside the water electrolyzer.

The present disclosure has been made under these circumstances, and according to an embodiment of the present invention, an object is to provide a method for producing a dry ion exchange membrane with which a water electrolyzer with suppressed leakage can be produced.

### Solution to Problem

The present disclosure includes the following configurations.

[1]

A dry ion exchange membrane production method, which comprises drying a wet ion exchange membrane that contains a fluorinated polymer having ion exchange groups wetted with a liquid medium to remove the liquid medium thereby to obtain a dry ion exchange membrane,
wherein the drying of the wet ion exchange membrane is initiated from a state where the amount of the liquid medium attached to the surface of the wet ion exchange membrane is 40 g/m² or more and 600 g/m² or less.
   [2]

The dry ion exchange membrane production method according to [1], wherein the amount of the liquid medium attached to the surface of the wet ion exchange membrane is 50 g/m² or more and 300 g/m² or less.

[3]

The dry ion exchange membrane production method according to [1] or [2], wherein the drying temperature is 60 to 150 °C.

[4]

The dry ion exchange membrane production method according to any one of [1] to [3], wherein the drying is initiated from a state where the content of the liquid medium in the wet ion exchange membrane is 60 mass % or more and 200 mass % or less to the total mass of the dry ion exchange membrane.

[5]

The dry ion exchange membrane production method according to any one of [1] to [4], wherein the fluorinated polymer has an ion exchange capacity of 0.90 to 2.05 meq/g dry resin.

[6]

The dry ion exchange membrane production method according to any one of [1] to [5], wherein the fluorinated polymer has units represented by the formula (1):

—[CF₂—CF(-L-(SO₃M)ₙ)]- formula (1)
in the formula (1), L is a (n+1)-valent perfluorohydrocarbon group which may contain an etheric oxygen atom, M is a hydrogen atom, an alkali metal or a quaternary ammonium cation, and n is 1 or 2.
   [7]

The dry ion exchange membrane production method according to any one of [1] to [6], wherein the wet ion exchange membrane contains a reinforcing material in its inside or on its surface.

[8]

The dry ion exchange membrane production method according to [7], wherein the reinforcing material contains at least one type of reinforcing yarns selected from the group consisting of reinforcing yarns formed of a polytetrafluoroethylene, reinforcing yarns formed of a tetrafluoroethylene/perfluoroether copolymer, reinforcing yarns formed of a polyphenylene sulfide, reinforcing yarns formed of a polyether ether ketone, reinforcing yarns formed of a nylon and reinforcing yarns formed of a polypropylene.

[9]

The dry ion exchange membrane production method according to any one of [1] to [8], wherein the dry ion exchange membrane is used as an electrolyte membrane contained in a membrane electrode assembly of a water electrolyzer.

### Advantageous Effects of Invention

According to an embodiment of the present invention, it is possible to provide a method for producing a dry ion exchange membrane with which a water electrolyzer with suppressed leakage can be produced.

### DESCRIPTION OF EMBODIMENTS

The following definitions of terms apply throughout the present specification and claims unless otherwise specified.

An “ion exchange group” refers to a group containing at least one ion exchangeable for a different ion, such as a sulfonic acid functional group and a carboxylic acid functional group as described below.

A “sulfonic acid functional group” refers to a sulfonic acid group (—SO₃H) or a sulfonate group. The sulfonate group may be, for example, (—SO₃⁻)Ma⁺, (—SO₃⁻)₂Mb²⁺ or (—SO₃⁻)₃Mc³⁺ (where Ma⁺ is an alkali metal ion or a quaternary ammonium cation; Mb²⁺ is a divalent metal ion; Mc³⁺ is a trivalent metal ion). When there are two ligands, the number of ion exchange groups is counted as 2, and when there are three ligands, the number of ion exchange groups is counted as 3.

A “carboxylic acid functional group” refers to a carboxylic acid group (—COOH) or a carboxylate group. The carboxylate group may be, for example, (—COO⁻)Ma⁺, (—COO⁻)₂Mb²⁺ or (—COO⁻)₃Mc³⁺ (where Ma⁺ is an alkali metal ion or a quaternary ammonium cation; Mb²⁺ is a divalent metal ion; and Mc³⁺ is a trivalent metal ion). When there are two ligands, the number of ion exchange groups is counted as 2, and when there are three ligands, the number of ion exchange groups is counted as 3.

A “precursor membrane” refers to a membrane containing a polymer having groups convertible to ion exchange groups.

A “group convertible to an ion exchange group” refers to a group that can be converted to an ion exchange group by known treatments such as hydrolysis and conversion to acid form.

A “group convertible to a sulfonic acid functional group” refers to a group that can be converted to a sulfonic acid functional group by known treatments such as hydrolysis and conversion to acid form.

A “group convertible to a carboxylic acid functional group” refers to a group that can be converted to a carboxylic acid functional group by known treatments such as hydrolysis and conversion to acid form.

A “unit” in a polymer refers to an atomic group derived from a single monomer molecule, which is formed by polymerization reaction of the monomer. A unit may be an atomic group formed directly by polymerization or may be an atomic group formed by polymerization followed by modification to a partially different structure. In the following, in some cases, units derived from a certain monomer will be represented by the monomer name, followed by “units”.

A numerical range expressed using “to” means a range including numerical values described before and after “to” as the lower and upper limits. In a series of numerical ranges described in the present specification, the upper limit or lower limit of a numerical range may be replaced by the upper limit or lower limit of another numerical range in the same series. The upper limit or lower limit of any numerical range described in the present specification may be replaced by any of numerical values indicated in Examples.

### [Dry Ion Exchange Membrane Production Method]

The dry ion exchange membrane production method of the present disclosure (hereinafter also referred to as “the present production method”) is a dry ion exchange membrane production method, which comprises drying a wet ion exchange membrane that contains a fluorinated polymer having ion exchange groups (hereinafter also referred to as “fluorinated polymer (I)”) wetted with a liquid medium to remove the liquid medium thereby to obtain a dry ion exchange membrane, wherein the drying of the wet ion exchange membrane is initiated from a state where the amount of the liquid medium such as water attached to the surface of the wet ion exchange membrane is 40 g/m² or more and 600 g/m² or less.

By using the dry ion exchange membrane obtained by the present production method, a water electrolyzer from which leakage is suppressed can be produced. The reason in detail has not been clearly understood yet but is estimated as follows.

The wet ion exchange membrane is wetted with a medium used for hydrolysis or counter ion exchange of the fluorinated polymer having groups convertible to ion exchange groups, water used for washing after the treatment, etc. In such a case, the liquid medium in an amount that exceeds the saturated water absorption of the membrane (e.g. the after-described precursor membrane) used for production of the wet ion exchange membrane, is not adsorbed in the membrane but is attached to the surface of the membrane. Accordingly, the liquid medium may sometimes be attached to the surface of the wet ion exchange membrane.

If drying is conducted in a state where the amount of the liquid medium attached to the surface of the wet ion exchange membrane is too large, uneven drying may occur, and thus the membrane thickness of the wet ion exchange membrane will be non-uniform. Further, if drying is conducted in a state where the amount of the liquid medium attached to the surface of the wet ion exchange membrane is too small, dimensional change will occur before the drying, and the membrane thickness of the dry ion exchange membrane will be non-uniform. As a result, wrinkles are likely to form when the dry ion exchange membrane is wound into a roll.

If a wrinkled dry ion exchange membrane is used to produce a membrane electrode assembly and a gasket is attached to a periphery of the membrane electrode assembly, due to the wrinkles on the dry ion exchange membrane, a gap may form between the gasket and the membrane electrode assembly. If the membrane electrode assembly with such a gap is applied to a water electrolyzer and supply of the electrolytic solution is initiated, the electrolytic solution may leak through the gap. Leakage of the electrolytic solution outside the water electrolyzer is estimated to be due to the above mechanism.

### <Wet Ion Exchange Membrane>

The wet ion exchange membrane used in the present production method is an ion exchange membrane wetted with a liquid medium. The fluorinated polymer (I) contained in the wet ion exchange membrane contains a liquid medium and is swollen.

The content of the liquid medium in the wet ion exchange membrane is, to the total mass of the dry ion exchange membrane, preferably 20 mass % or more, more preferably 25 mass % or more, further preferably 30 mass % or more, particularly preferably 60 mass % or more, in that uneven drying during roll conveying is suppressed and the membrane flatness will improve and formation of wrinkles during conveying can be suppressed.

The content of the liquid medium in the wet ion exchange membrane is, to the total mass of the dry ion exchange membrane, preferably 200 mass % or less, more preferably 180 mass % or less, further preferably 160 mass % or less, and particularly preferably 140 mass % or less, in view of excellent drying efficiency.

In this specification, in a case where the liquid medium is attached to the surface of the wet ion exchange membrane, the above content of the liquid medium in the wet ion exchange membrane includes the amount of the liquid medium attached to the surface.

The content of the liquid medium in wet ion exchange membrane is obtained by the method in the after-described Examples.

When the after-described drying of the wet ion exchange membrane is conducted (that is at the drying start point), the amount of the liquid medium attached to the surface of the wet ion exchange membrane is 600 g/m² or less, and in view of more excellent effects of the present disclosure, preferably 400 g/m² or less, more preferably 300 g/m² or less, further preferably 250 g/m² or less, particularly preferably 200 g/m² or less.

When the after-described drying of the wet ion exchange membrane is conducted (that is at the drying start point), the amount of the liquid medium attached to the surface of the wet ion exchange membrane is, with a view to suppressing deformation (e.g. curling) due to rapid drying of the wet ion exchange membrane, preferably 40 g/m² or more, more preferably 50 g/m² or more, further preferably 100 g/m² or more.

The amount of the liquid medium attached to the surface of the wet ion exchange membrane is obtained by the method in the after-described Examples.

The membrane thickness of the wet ion exchange membrane is, with a view to maintaining a certain strength, preferably 30 μm or more, more preferably 40 μm or more, and in view of increasing the current efficiency and the voltage efficiency, preferably 500 μm or less, more preferably 300 μm or less, further preferably 250 μm or less.

The wet ion exchange membrane preferably has a surface roughness to a certain extent. Particularly, the wet ion exchange membrane preferably has the after-described reinforcing material in its inside or on its surface. In a case where the wet ion exchange membrane contains a reinforcing material, the reinforcing material makes slight concavo-convex parts on the surface of the wet ion exchange membrane. This helps the wet ion exchange membrane to maintain the liquid medium on its surface, and makes the amount of the liquid medium attached to the surface of the wet ion exchange membrane be adjusted to be appropriate.

The water contact angle on the surface of the wet ion exchange membrane is, in that an appropriate amount of the liquid medium is maintained on the surface of the wet ion exchange membrane, preferably 50 to 100°, more preferably 55 to 85°. When the wet ion exchange membrane contains a reinforcing material, the contact angle tends to be small, and when not, the contact angle tends to be large. The contact angle is obtained by the method in the after-described Examples.

### (Liquid Medium)

The liquid medium may be any medium which can swell the fluorinated polymer (I), and may be an organic solvent or water. The liquid medium may be either one of an organic solvent and water, or a mixture of them. Single type of the organic solvent may be used or two or more types may be used in combination.

The organic solvent which can swell the fluorinated polymer (I) may be a water-soluble organic solvent. In this specification, the water-soluble organic solvent refers to an organic solvent which readily dissolve in water and, specifically, preferred is an organic solvent having a solubility of 0.1 g or more in 1000 ml of water (20 °C), more preferably an organic solvent having the solubility of 0.5 g or more. The water-soluble organic solvent preferably contains at least one member selected from the group consisting of aprotic organic solvents, alcohols and amino alcohols, more preferably contains at least an aprotic organic solvent.

Single type of the organic solvent may be used or two or more types may be used in combination.

Specific examples of the aprotic organic solvents include dimethyl sulfoxide, N,N-dimethylformamide, N,N-dimethylacetamide, N-methyl-2-pyrrolidone and N-ethyl-2-pyrrolidone. Preferred is dimethyl sulfoxide.

Specific examples of the alcohols include methanol, ethanol, isopropanol, butanol, methoxyethoxyethanol, butoxyethanol, butylcarbitol, hexyloxyethanol, octanol, 1-methoxy-2-propanol and ethylene glycol.

Specific examples of the amino alcohols include ethanolamine, N-methyl ethanolamine, N-ethyl ethanolamine, 1-amino-2-propanol, 1-amino-3-propanol, 2-aminoethoxyethanol, 2-aminothioethoxyethanol and 2-amino-2-methyl-1-propanol.

### (Fluorinated Polymer (I))

The ion exchange capacity of the fluorinated polymer (I) is preferably 0.90 meq/g dry resin (hereinafter also referred to as meq/g) or more, more preferably 1.00 meq/g or more, further preferably more than 1.05 meq/g, particularly preferably 1.10 meq/g or more, in view of excellent voltage efficiency.

The ion exchange capacity of the fluorinated polymer (I) is preferably 2.05 meq/g or less, more preferably 1.50 meq/g or less, particularly preferably 1.25 meq/g or less, in view of the balance between the current efficiency and the voltage efficiency.

The fluorinated polymer (I) may be a fluorinated polymer having sulfonic acid functional groups (hereinafter also referred to as “fluorinated polymer(S)”), and a fluorinated polymer having carboxylic acid functional groups (hereinafter also referred to as “fluorinated polymer (C)”).

Single type of the fluorinated polymer (I) may be used, or two or more types may be used as stacked or mixed.

The wet ion exchange membrane may be an ion exchange membrane that contains the fluorinated polymer(S) or an ion exchange membrane that has the fluorinated polymer(S) and the fluorinated polymer (C) stacked in a laminate, preferably an ion exchange membrane that contains the fluorinated polymer(S), and in view of applicability to water electrolysis, more preferably an ion exchange membrane that contains only the fluorinated polymer(S) as the fluorinated polymer (I).

Now, mainly an embodiment of the fluorinated polymer(S) will be described in detail.

The fluorinated polymer(S) preferably has units based on a fluoroolefin and units having a sulfonic acid functional group and a fluorine atom.

The fluorinated olefin may be, for example, a C₂₋₃ fluoroolefin having one or more fluorine atom in its molecule. Specific examples of the fluoroolefin include tetrafluoroethylene (hereinafter also referred to as “TFE”), chlorotrifluoroethylene, vinylidene fluoride, vinyl fluoride or hexafluoropropylene. Among them, TFE is preferred, in terms of the monomer production cost, the reactivity with other monomers and the ability to give the fluorinated polymer(S) with excellent properties.

Single type of the fluorinated olefin may be used, or two or more types may be used in combination.

The units having a sulfonic acid functional group and a fluorine atom are preferably units represented by the formula (1).

—[CF₂—CF(-L-(SO₃M)ₙ)]- formula (1)

L is a (n+1)-valent perfluorohydrocarbon group which may contain an etheric oxygen atom.

The etheric oxygen atom may be located at a terminal end or may be located between carbon atoms of the perfluorohydrocarbon group.

The number of carbon atoms in the (n+1)-valent perfluorohydrocarbon group is preferably 1 or more, more preferably 2 or more, and preferably 20 or less, more preferably 10 or less.

As L, preferred is a (n+1)-valent perfluoroaliphatic hydrocarbon group which may contain an etheric oxygen atom. More preferred is a divalent perfluoroalkylene group which may contain an etheric oxygen atom as corresponding to an embodiment of n=1, or a trivalent perfluoroaliphatic hydrocarbon group which may contain an etheric oxygen atom as corresponding to an embodiment of n=2.

The above-mentioned divalent perfluoroalkylene group may be linear or branched.

M is a hydrogen atom, an alkali metal or a quaternary ammonium cation and the two M may be the same or different.

n is 1 or 2.

The units represented by the formula (1) are preferably units represented by the formula (1-1), units represented by the formula (1-2), units represented by the formula (1-3) and units represented by the formula (1-4).

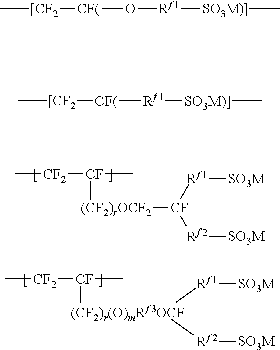

R^{f1} is a perfluoroalkylene group which may contain an oxygen atom between carbon atoms. The number of carbon atoms in the perfluoroalkylene group is preferably 1 or more, more preferably 2 or more, and is preferably 20 or less, more preferably 10 or less.

R^{f2} is a single bond or a perfluoroalkylene group which may contain an oxygen atom between carbon atoms. The number of carbon atoms in the perfluoroalkylene group is preferably 1 or more, more preferably 2 or more, and is preferably 20 or less, more preferably 10 or less.

R^{f3} is a single bond or a perfluoroalkylene group which may contain an oxygen atom between carbon atoms. The number of carbon atoms in the perfluoroalkylene group is preferably 1 or more, more preferably 2 or more, and is preferably 20 or less, more preferably 10 or less.

r is 0 or 1.

m is 0 or 1.

In the formulae, M is as defined above.

The units represented by the formula (1-1) and the units represented by the formula (1-2) are more preferably units represented by the formula (1-5).

—[CF₂—CF(—(CF₂)ₓ—(OCF₂CFY)_{y}—O—(CF₂)_{z}—SO₃M)]- formula (1-5)
x is 0 or 1, y is an integer of 0 to 2, z is an integer of 1 to 4, Y is F or CF₃, and M is as defined above.

Specific examples of the units represented by the formula (1-1) are the following units. In the formulae, w is an integer of 1 to 8, x is an integer of 1 to 5, and M is as defined above.

—[CF₂—CF(—O—(CF₂)_{w}—SO₃M)]-

—[CF₂—CF(—O—CF₂CF(CF₃)—O—(CF₂)_{w}—SO₃M)]-

—[CF₂—CF(—(O—CF₂CF(CF₃))ₓ—SO₃M)]-

Specific examples of the units represented by the formula (1-2) are the following units. In the formulae, w is an integer of 1 to 8, and M is as defined above.

—[CF₂—CF(—(CF₂)_{w}—SO₃M)]-

—[CF₂—CF(—CF₂—O—(CF₂)_{w}—SO₃M)]-

The units represented by the formula (1-3) are preferably units represented by the formula (1-3-1). In the formula, M is as defined above.

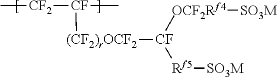

R^{f4} is a C₁₋₆ linear perfluoroalkylene group, and R^{f5} is a single bond or a C₁₋₆ linear perfluoroalkylene group which may contain an oxygen atom between carbon atoms. r and M are as defined above.

Specific examples of the units represented by the formula (1-3-1) are as follows.

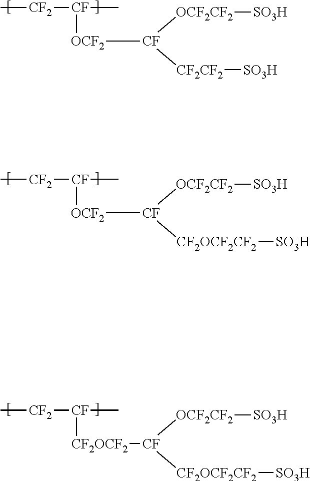

The units represented by the formula (1-4) are preferably units represented by the formula (1-4-1). In the formula, R^{f1}, R^{f2} and M are as defined above.

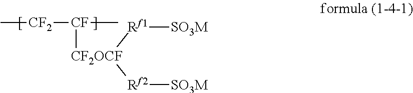

Specific examples of the units represented by the formula (1-4-1) are as follows.

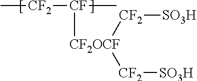

Single type of the units having a sulfonic acid functional group and a fluorine atom may be used, or two or more types may be used in combination.

The fluorinated polymer (I) may have, in addition to the units based on the fluorinated olefin and the units having a sulfonic acid functional group and a fluorine atom, units based on other monomer.

Specific examples of the other monomer include CF₂═CFR^{f6} (wherein R^{f6} is a C₂₋₁₀ perfluoroalkyl group), CF₂═CF—OR^{f7} (wherein R^{f7} is a C₁₋₁₀ perfluoroalkyl group), and CF₂═CFO(CF₂)ᵥCF═CF₂ (wherein v is an integer of 1 to 3).

The content of the units based on the other monomer is, with a view to maintaining the ion exchange capacity, preferably 30 mass % or less to all units in the fluorinated polymer (I).

The content of the fluorinated polymer (I) is preferably 30 to 90 mass % to the total mass of the wet ion exchange membrane.

The wet ion exchange membrane may have a single layer structure or a multilayered structure. In the case of a multilayered structure, for example, an ion exchange membrane that contains the fluorinated polymer(S) and has several layers differing in the ion exchange capacity or the units stacked may be mentioned. Further, as described above, layers of the fluorinated polymer (C) may be stacked.

The wet ion exchange membrane may contain a reinforcing material in its inside or on its surface. That is, the wet ion exchange membrane may contain the fluorinated polymer (I) swollen by the liquid medium and the reinforcing material.

The reinforcing material is preferably a member derived from a reinforcing cloth (preferably a woven fabric). In addition to the reinforcing cloth, fibrils and a porous body may be mentioned as the reinforcing material.

The reinforcing fabric is constituted by warp yarns and weft yarns, and the warp yarns and the weft yarns being preferably orthogonal to each other. The reinforcing fabric is preferably constituted by reinforcing yarns and sacrificial yarns.

The reinforcing yarns are preferably yarns made of a material which does not elute even when the reinforcing fabric is immersed in an aqueous alkaline solution (for example a 32 mass % aqueous sodium hydroxide solution). Specifically, the reinforcing yarns are preferably at least one type of reinforcing yarns selected from the group consisting of reinforcing yarns formed of a polytetrafluoroethylene (hereinafter also referred to as PTFE), reinforcing yarns formed of a tetrafluoroethylene/perfluoroether copolymer (hereinafter also referred to as PFA, the perfluoroether is preferably a perfluoroalkyl vinyl ether), reinforcing yarns formed of a polyphenylene sulfide (hereinafter also referred to as PPS), reinforcing yarns formed of a polyether ether ketone (hereinafter also referred to as PEEK), reinforcing yarns formed of a nylon and reinforcing yarns formed of a polypropylene.

The sacrificial yarns are yarns of which at least a part elutes in an environment of operation of an apparatus including the ion exchange membrane, and preferably such yarns that they elute into an aqueous alkaline solution when the reinforcing fabric is immersed in the aqueous alkaline solution. The sacrificial yarns may be a monofilament consisting of one filament, or a multifilament composed of two or more filaments.

At the time of handling, for example at the time of production of the wet ion exchange membrane and at the time of attaching the ion exchange membrane to a cell, the strength of the ion exchange membrane is kept by the sacrificial yarns, and in a cell operation environment, the sacrificial yarns elute and the resistance of the membrane decreases.

The wet ion exchange membrane may have an inorganic particle layer that contains inorganic particles and a binder. The inorganic particle layer is provided preferably on at least one surface of the wet ion exchange membrane, preferably on both the surfaces.

By the wet ion exchange membrane having an inorganic particle layer, the ion exchange membrane has improved hydrophilicity and has ion conductivity improved.

### (Wet Ion Exchange Membrane Production Method)

The wet ion exchange membrane may be obtained by a known method, for example, by the method as described in WO2018/070444. That is, the wet ion exchange membrane is obtained by a polymerization step of polymerizing a monomer having a group convertible to an ion exchange group (preferably a sulfonic acid functional group) to obtain a fluorinated polymer having groups convertible to ion exchange groups (preferably sulfonic acid functional groups), a membrane-forming step of forming the fluorinated polymer into a membrane that contains a fluorinated polymer having groups convertible to sulfonic acid functional groups (hereinafter also referred to as “precursor membrane”) and a hydrolysis step of hydrolyzing the groups convertible to ion exchange groups (preferably sulfonic acid functional groups) in the precursor membrane to ion exchange groups (preferably sulfonic acid functional groups). After the hydrolysis step, a step of converting counter ions of the ion exchange groups (for example conversion to acid form) with hydrogen, sodium or potassium may be conducted.

In a case where the wet ion exchange membrane is a laminate, a plurality of precursor membranes may be prepared and stacked, followed by hydrolysis. Further, in a case where the wet ion exchange membrane contains the reinforcing material, the reinforcing material may be stacked between the precursor membranes when the precursor membranes are stacked.

In the ion exchange membrane after the hydrolysis or the counter ion exchange, usually the fluorinated polymer is wetted e.g. with the medium used for the hydrolysis or the counter ion exchange or with water used for washing after the hydrolysis or the counter ion exchange. The ion exchange membrane in a wetted state may be dried as it is as the wet ion exchange membrane.

However, in order that drying of the wet ion exchange membrane is initiated from a state where the amount of the liquid medium attached to the surface of the wet ion exchange membrane is 40 g/m² or more and 600 g/m² or less, it is preferred to conduct a treatment to adjust the wetted state of the ion exchange membrane after the hydrolysis of the counter ion exchange.

Specifically, in a case where the ion exchange membrane after the hydrolysis or the counter ion exchange is in a poorly wetted state, it is preferred to conduct a treatment to attach an aqueous medium to the surface of the ion exchange membrane, for example a treatment to spray an aqueous medium over the surface of the ion exchange membrane or a treatment to immerse the ion exchange membrane in an aqueous medium.

On the other hand, in a case where the ion exchange membrane after the hydrolysis or the counter ion exchange is in an excessively wetted state, it is preferred to conduct a treatment to remove the aqueous medium attached to the surface of the ion exchange membrane, for example a treatment to wipe off the aqueous medium attached to the surface of the ion exchange membrane.

### <Drying Method>

In the present production method, drying of the wet ion exchange membrane is initiated from a state where the amount of the liquid medium attached to the surface of the wet ion exchange membrane is 600 g/m² or less to obtain a dry ion exchange membrane.

Drying of the wet ion exchange membrane may be natural drying or heat drying using a known drying apparatus, and is preferably drying by heating in view of drying efficiency.

In a case where heating is conducted for drying the wet ion exchange membrane, the drying temperature (heat temperature) of the wet ion exchange membrane is preferably 60 °C or higher, more preferably 80 °C or higher, further preferably 90 °C or higher, in view of the drying efficiency, and is preferably 150 °C or lower, more preferably 120 °C or lower, further preferably 105 °C or lower, with a view to further suppressing formation of wrinkles by rapid drying.

Particularly, the drying temperature of the wet ion exchange membrane is, in view of small residual internal stress at the time of drying, preferably equal to or higher than the softening point of the fluorinated polymer (I), more preferably higher by 10 °C or more than the softening point of the fluorinated polymer (I), further preferably higher by 20 °C or more than the softening point of the fluorinated polymer (I).

The softening point of the fluorinated polymer(S) is measured by the method in the after-described Examples.

The drying temperature of the wet ion exchange membrane refers to the surface temperature of the wet ion exchange membrane.

Drying of the wet ion exchange membrane is conducted, in order to suppress dimensional changes of the ion exchange membrane as between before and after the drying and to further suppress formation of wrinkles, preferably by a drying method while the periphery of the wet ion exchange membrane is restricted (for example a method of sandwiching and fixing the periphery of the wet ion exchange membrane by a metal frame, or a method of putting pins in the periphery of the wet ion exchange membrane and fixing the membrane) or by a drying method while a load is applied to the periphery of the wet ion exchange membrane.

The present production method may be conducted by roll-to-roll process. In such a case, a continuous precursor membrane roll is unwound, the respective treatments of the present production method are conducted, and the dry ion exchange membrane is wound into a roll.

The present production method may include a conveying step. Particularly, it preferably has a conveying step after production of the wet ion exchange membrane and before the start of the drying step. In the conveying step, the wet ion exchange membrane is conveyed between the steps preferably e.g. by a belt conveyer.

The conveying rate is preferably 0.0320 m/sec or less, more preferably 0.0167 m/sec or less, further preferably 0.0116 m/sec or less, particularly preferably 0.0083 m/sec or less. Further, the conveying rate is preferably 0.0020 m/sec or more, more preferably 0.0040 m/sec or more. The conveying rate refers to a distance (m) which a point on a film moves per second, considering that a film-shaped object is conveyed in a longitudinal direction of the film.

The conveying temperature may be, for example, 0 °C or higher and 100 °C or lower, and is preferably 10 °C or higher and 50 °C or lower. The conveying temperature refers to a temperature of the conveying environment (room temperature in a case where it is in a room).

The amount of the liquid medium attached to the surface of the wet ion exchange membrane can properly be adjusted also by adjusting the conveying conditions. Particularly adjustment of the conveying rate will readily adjust the amount of the liquid medium attached to the surface of the wet ion exchange membrane uniformly without unevenness and is less likely to form wrinkles on the dry ion exchange membrane, and is thus preferred to the above wiping.

In the dry ion exchange membrane obtained by the present production method, the content of the liquid medium is, to the total mass of the dry ion exchange membrane, preferably 15 mass % or less, more preferably 12 mass % or less, further preferably 10 mass % or less. The lower limit may be 1 mass %.

The thickness of the dry ion exchange membrane obtained by the present production method is, with a view to keeping a certain strength, preferably 20 μm or more, more preferably 40 μm or more, and with a view to increasing the current efficiency and the voltage efficiency, preferably 300 μm or less, more preferably 200 μm or less.

The standard deviation of the thickness of the dry ion exchange membrane obtained by the present production method is, with a view to improving flatness of the membrane and further suppressing wrinkles which may be formed while conveyed, preferably 10 μm or less, more preferably 5 μm or less. The lower limit of the standard deviation of the thickness of the dry ion exchange membrane is usually 0.1 μm.

The dry ion exchange membrane obtained by the present production method is suitable as an electrolyte membrane contained in a membrane electrode assembly of a water electrolyzer (polymer electrolyte membrane water electrolyzer), and may be used for applications other than the above water electrolyzers.

Specific examples of the other applications include various batteries such as polymer electrolyte fuel cells, direct methanol fuel cells, redox flow batteries and air batteries, and various electrolyzers for alkali water electrolysis, ozone water electrolysis, chlor-alkali electrolysis, organic electrolysis, and electrolysis of chloride, oxide, and the like. In addition, the ion exchange membrane may be used for selective cation transport at the membrane-electrode interface as a separator or a solid electrode in various types of electrochemical cells. Further, in addition to the electrochemical applications, it may be used for gas sensors, biosensors, luminous devices, optical devices and organic sensors, solubilization of carbon nanotubes, actuators, catalysts, etc.

### EXAMPLES

Now, the present invention will be described in further detail with reference to Examples. Ex. 1 to 3 correspond to Examples of the present invention; and Ex. 4 and 5 correspond to Comparative Examples. It should be understood that the present invention is by no means restricted thereto.

### [Thickness of Membrane]

The thickness of the membrane was measured on a magnified cross-sectional image of the membrane (e.g. at a magnification of 100) taken by an optical microscope (model “BX-51”, manufactured by Olympus Corporation), and an arithmetic mean of thickness measurements at arbitrary 20 points was taken as the thickness of the membrane.

In the case where there were convex-concave parts on the surface of the membrane, the thickness of the membrane is an arithmetic mean of thickness measurements at total 20 points, i.e., 10 points on concave parts of the membrane and 10 points on convex parts of the membrane. In the case where yarns constituting the woven fabric are contained in convex parts of the membrane, the thickness of such yarns is subtracted from the thickness of the convex parts.

### [Ion Exchange Capacity of Fluorinated Polymer]

The weight of a fluorinated polymer was measured, after 24 hours of incubation in a glove box purged with dry nitrogen, as the dry mass of the fluorinated polymer. Then, the fluorinated polymer was immersed in a 2 mol/L aqueous sodium chloride solution at 60 °C for 1 hour. After the fluorinated polymer was washed with ultrapure water and recovered, the solution in which the fluorinated polymer had been immersed was titrated with 0.1 mol/L aqueous sodium hydroxide solution to determine the ion exchange capacity of the fluorinated polymer.

### [Softening Point of Fluorinated Polymer]

The softening point of the fluorinated polymer was measured using a dynamic viscoelasticity measurement apparatus as follows. First, using the dynamic viscoelasticity measuring apparatus (manufactured by IT Keisoku Seigyo K.K., DVA-225), dynamic viscoelasticity measurement was conducted with a sample width of 5.0 mm with a distance between chucks of 15 mm at a measurement frequency of 1 Hz at a temperature increasing rate of 2 °C/min at a tensile mode. tan δ (loss tangent) was calculated from the ratio of the loss elastic modulus E″ and the storage elastic modulus E′, that is E″/E′, to prepare a tan δ-temperature curve. From the prepared tan δ-temperature curve, a peak temperature within a range of −100 to 300 °C was read and taken as the softening point.

### [Content of Liquid Medium in Wet Ion Exchange Membrane]

The content of the liquid medium in the wet ion exchange membrane was calculated from the following formula based on the mass of the membrane after 0.6 g of the wet ion exchange membrane was dried at 90 °C for 16 hours, and the mass of the wet ion exchange membrane before drying.

Content of liquid medium in wet ion exchange membrane (mass %)=100×{(mass of wet ion exchange membrane before drying)−(mass of membrane after drying)}/(mass of membrane after drying)

### [Amount of Liquid Medium Attached to Surface of Wet Ion Exchange Membrane]

The wet ion exchange membrane (1 m×1 m×30 to 200 μm in thickness) immediately before drying was wiped with filter paper (Qualitative filter paper, No. 2, ADVANTEC) until the aqueous medium attached to the surface were visually unrecognizable. The amount of the liquid medium attached to the surface of the wet ion exchange membrane was calculated from the following formula based on the mass of filter paper before the above wiping and the mass of the filter paper after the wiping.

Amount of liquid medium attached to surface of wet ion exchange membrane (g/m²)={(mass of filter paper after wiping aqueous medium off)−(mass of filter paper before wiping aqueous medium off)}/(surface area of wet ion exchange membrane)

### [Water Contact Angle on Wet Ion Exchange Membrane]

The electrolyte membrane was immersed in deionized water at 23 °C for 60 minutes. The surface water on the electrolyte membrane in a wet state was wiped off with filter paper, and on the electrolyte membrane, 2 μL of deionized water was dropped in a room temperature environment, and the contact angle was measured with a waiting time for measurement set to 100 mS without curvature correction. The contact angle was measured by PCA-11 manufactured by Kyowa Interface Science Co., Ltd. and obtained by sessile drop method (θ/2 method). An arithmetic mean of five measurements in each Ex. was taken.

### [Standard Deviation of Thickness of Dry Ion Exchange Membrane]

The standard deviation (μm) of the thickness of the dry ion exchange membrane was obtained from thickness measurements at 20 points on the dry ion exchange membrane obtained by the measurement method of the above [Thickness of membrane].

In the case where there are convex-concave parts on the surface of the dry ion exchange membrane, the standard deviation (μm) of the thickness of the dry ion exchange membrane was obtained from 10 points on concave parts on the dry ion exchange membrane.

### [Wrinkles on Dry Ion Exchange Membrane]

The dry ion exchange membrane wound into a roll obtained in the after-described Ex. was unwound and the number of wrinkles of 10 mm or more in a region of the dry ion exchange membrane (1 m in width direction and 1 m in the machine direction) was visually counted.

Evaluation is made based on the number of wrinkles.
A: number of wrinkles: 0 to 3
B: number of winkles: 4 to 7
C: number of wrinkles: 8 to 10
D: number of wrinkles: 11 or more.

Practically preferred is grade C or higher (A, B or C).

[Evaluation of Leakage from Water Electrolyzer]

### <Production of Membrane Electrode Assembly>

A polymer (ion exchange capacity: 1.10 meq/g dry resin) produced by copolymerization of CF₂═CF₂ and monomer (X) described later, followed by conversion to acid form through hydrolysis and acid treatment, was dispersed in a solvent of water/ethanol in a ratio of 40/60 (mass %) to obtain a dispersion with a solid content of 26.0% (hereinafter also referred to as “dispersion Y”).

The obtained dispersion Y (33.0 g) was mixed with ethanol (18.06 g) and ZEORORA H (manufactured by Zeon Corporation) (10.58 g) by a planetary centrifugal mixer (THINKY MIXER, manufactured by THINKY CORPORATION) at 2200 rpm for 5 minutes. The mixed composition (54.06 g) was mixed with ethanol (46.44 g) and water (75.75 g) and further mixed with an iridium oxide catalyst (40.0 g) (manufactured by TANAKA PRECIOUS METAL TECHNOLOGIES Co., Ltd.) containing 74.8 mass % iridium and having a specific surface area of 100 m²/g. The resulting mixed composition was processed in a planetary bead mill (rotation speed: 300 rpm) for 90 minutes to obtain an anode catalyst ink with a solid content of 22 mass %.

The anode catalyst ink was applied by an applicator to an ETFE sheet such that the amount of iridium applied was 1.0 mg/cm², dried at 80 °C for 10 minutes and heat-treated at 150 °C for 15 minutes, thereby obtaining an anode catalyst layer decal.

To a supported catalyst having 46 mass % platinum supported on a carbon powder (“TEC10E50E” manufactured by TANAKA PRECIOUS METAL TECHNOLOGIES Co., Ltd.) (11 g), water (59.4 g) and ethanol (39.6 g) were added and milled in an ultrasonic homogenizer to obtain a catalyst dispersion.

To the catalyst dispersion, a preliminarily kneaded mixture (29.2 g) of the dispersion Y (20.1 g), ethanol (11 g) and ZEORORA H (manufactured by Zeon Corporation) (6.3 g) was added. Further, to the obtained dispersion, water (3.66 g) and ethanol (7.63 g) were added and mixed in a paint conditioner for 60 minutes to obtain a cathode catalyst ink with a solid content of 10.0 mass %.

The cathode catalyst ink was applied by a die coater to an ETFE sheet, dried at 80 °C and heat-treated at 150 °C for 15 minutes, thereby obtaining a cathode catalyst layer decal with a platinum content of 0.4 mg/cm².

The catalyst layer of the anode catalyst layer decal was arranged to face one side of the dry ion exchange membrane in each Ex., and the catalyst layer of the cathode catalyst layer decal was arranged to face the other side of the ion exchange membrane. Then, the anode catalyst layer, the dry ion exchange membrane and the cathode catalyst layer were laminated together by hot pressing for 10 minutes at a press temperature of 150 °C and a pressure of 3 MPa. After cooling to 70 °C and releasing the pressure, the resulting laminate was taken out, and the ETFE sheets of the anode catalyst layer decal and the cathode catalyst layer decal were peeled off to obtain a membrane electrode assembly having an electrode area of 16 cm².

### <Production of Water Electrolyzer>

The obtained membrane electrode assembly was heat-treated at 150 °C for 15 minutes, the periphery of the membrane electrode assembly was sandwiched between several sheets of subgaskets made of PPS (polyphenylene sulfide) and PEN (polyethylene naphthalate) stacked, and set in a water electrolysis evaluation jig EH50-25 (manufactured by Greenlight innovation) to obtain a water electrolyzer.

### (Evaluation Method)

To fully hydrate the polymer electrolyte membrane and the ionomers in the electrodes, pure water at 80 °C and ordinary pressure with a conductivity of 1.0 μS/cm or less was supplied to both the anode side and the cathode side at a flow rate of 50 mL/min for 12 hours. Then, the cathode side was purged with nitrogen.

After the nitrogen purge, the water electrolyzer was operated by a direct current power source PWR1600L manufactured by Kikusui Electronics Corporation at a current density of 2 A/cm² for 300 hours by supplying pure water at 80 °C and ordinary pressure with a conductivity of 1.0 μS/cm or less to the anode side at a flow rate of 50 mL/min and keeping the pressure of gas generated from the cathode side at atmospheric pressure. The evaluation was made based on the following standards.
A: No leakage during operation for 300 hours.
B: Leakage observed during operation for 300 hours.

### [Production of Fluorinated Polymer (S′-1)]

CF₂═CF₂ and monomer (X) represented by the following formula (X) were copolymerized to obtain fluorinated polymer (S′-1) (ion exchange capacity: 1.25 meq/g).

CF₂═CF—O—CF₂CF(CF₃)—O—CF₂CF₂—SO₂F (X)

The ion exchange capacity described in [Production of fluorinated polymer (S′-1)] refers to the ion exchange capacity of the fluorinated polymer after hydrolysis of the fluorinated polymer (S′-1) by the after-described procedure.

### [Production of Film α1]

The fluorinated polymer (S′-1) was formed by melt-extrusion into film α1 (membrane thickness: 60 μm) formed of the fluorinated polymer (S′-1).

### [Production of Woven Fabric A1]

Using 18.6-denier yarns of PFA as warp yarns and weft yarns, woven fabric A1 was produced by plain weaving such that the density of the PFA yarns was 100 yarns/inch. The fabric weight of the woven fabric A1 was 16.3 g/m².

### Ex. 1 to 5

In Ex. 1, 2, 4 and 5, a PET film, the film α1, the woven fabric A1, the film α1 and a PET film were stacked in this order. In Ex. 3, no woven fabric A1 was used, and a PET film, the film α1, the film α1 and a PET film were stacked in this order.

The stacked members were thermally press-bonded together by a roll press machine at a temperature of 200 °C and a linear pressure of 40 kg/cm, and then, the transfer base materials (PET films) on both sides were peeled off at a temperature of 50 °C to obtain a precursor membrane.

The precursor membrane was conveyed into a dimethyl sulfoxide/potassium hydroxide/water=30/5.5/64.5 (mass ratio) solution at 95 °C so that the treatment time would be 30 minutes, to hydrolyze and convert the groups convertible to sulfonic acid functional groups in the precursor membrane to K form sulfonic acid functional groups (hydrolysis treatment), and then the membrane was washed with water. The obtained membrane was then conveyed into a 1M sulfuric acid at 40 to 50 °C to convert the terminal end groups of the sulfonic acid functional groups from K form to H form (conversion to acid form) to obtain a wet ion exchange membrane.

While the edge portion of the obtained wet ion exchange membrane was fixed, the wet ion exchange membrane was dried at a temperature equal to or higher than the softening point (105 °C) of the fluorinated polymer (drying treatment) to obtain a dry ion exchange membrane. Using the obtained dry ion exchange membrane, leakage from the water electrolyzer was evaluated. Further, 150 m of the obtained dry ion exchange membrane was wound into a roll and evaluation of wrinkles was conducted.

In each Ex., the amount of the aqueous medium attached to the surface of the wet ion exchange membrane at the start of the drying step may be adjusted to the value in Table 1 by the conveying rate in conveying step from after the conversion to acid form to before the drying step. Based on the conveying rate in Ex. 5 as a reference, how many times the conveying rate of each Ex. to the conveying rate in Ex. 5, is shown in Table 1. The conveying distance was 5 m, the temperature in the conveying environment was room temperature (25 °C), and the conveying time in Ex. 1 was 5 minutes.

The standard deviation of the thickness of the dry ion exchange membrane in Ex. 1 was 5 μm, and the standard deviation of the thickness of the dry ion exchange membrane in Ex. 4 was 15 μm.

TABLE 1

| | | Ex. | Ex. | Ex. | Ex. | Ex. |
|---|---|---|---|---|---|---|
| | | 1 | 2 | 3 | 4 | 5 |
| Wet ion | Content of liquid | 160 | 100 | 151 | 280 | 52 |
| exchange | medium in wet | | | | | |
| membrane | ion exchange | | | | | |
| | membrane | | | | | |
| | (mass %) | | | | | |
| | Amount of liquid | 322 | 161 | 255 | 644 | 32 |
| | medium attached | | | | | |
| | to surface of wet | | | | | |
| | ion exchange | | | | | |
| | membrane (g/m²) | | | | | |
| | Thickness (μm) | 200 | 200 | 171 | 200 | 200 |
| | Water contact | 58 | 58 | 86 | 58 | 58 |
| | angle (°) | | | | | |
| Dry ion | Thickness | 140 | 140 | 120 | 140 | 140 |
| exchange | (μm) | | | | | |
| membrane | Evaluation of | B | A | C | D | D |
| | wrinkles | | | | | |

| | | | | | |
|---|---|---|---|---|---|
| Conveying rate (times) | 10 | 5 | 10 | 20 | 1 |
| Evaluation of leakage from water | A | A | A | B | B |
| electrolyzer | | | | | |

As shown in Table 1, it was confirmed that when drying of a wet ion exchange membrane was initiated in a state where the amount of the liquid medium attached to the surface of the wet ion exchange membrane was 40 g/m² or more and 600 g/m² or less, and the obtained dry ion exchange membrane was applied to a water electrolyzer, leakage from the water electrolyzer could be suppressed.

This application is a continuation of PCT Application No. PCT/JP2024/043090, filed on Dec. 5, 2024, which is based upon and claims the benefit of priority from Japanese Patent Application No. 2023-207544 filed on Dec. 8, 2023. The contents of those applications are incorporated herein by reference in their entireties.

What is claimed is:

1. A dry ion exchange membrane production method, which comprises drying a wet ion exchange membrane that contains a fluorinated polymer having ion exchange groups wetted with a liquid medium to remove the liquid medium thereby to obtain a dry ion exchange membrane,
wherein the drying of the wet ion exchange membrane is initiated from a state where the amount of the liquid medium attached to the surface of the wet ion exchange membrane is 40 g/m² or more and 600 g/m² or less.

2. The dry ion exchange membrane production method according to claim 1, wherein the amount of the liquid medium attached to the surface of the wet ion exchange membrane is 50 g/m² or more and 300 g/m² or less.

3. The dry ion exchange membrane production method according to claim 1, wherein the drying temperature is 60 to 150 °C.

4. The dry ion exchange membrane production method according to claim 1, wherein the drying is initiated from a state where the content of the liquid medium in the wet ion exchange membrane is 60 mass % or more and 200 mass % or less to the total mass of the dry ion exchange membrane.

5. The dry ion exchange membrane production method according to claim 1, wherein the fluorinated polymer has an ion exchange capacity of 0.90 to 2.05 meq/g dry resin.

6. The dry ion exchange membrane production method according to claim 1, wherein the fluorinated polymer has units represented by the formula (1):
—[CF₂—CF(-L-(SO₃M)ₙ)]- formula (1)
in the formula (1), L is a (n+1)-valent perfluorohydrocarbon group which may contain an etheric oxygen atom, M is a hydrogen atom, an alkali metal or a quaternary ammonium cation, and n is 1 or 2.

7. The dry ion exchange membrane production method according to claim 1, wherein the wet ion exchange membrane contains a reinforcing material in its inside or on its surface.

8. The dry ion exchange membrane production method according to claim 7, wherein the reinforcing material contains at least one type of reinforcing yarns selected from the group consisting of reinforcing yarns formed of a polytetrafluoroethylene, reinforcing yarns formed of a tetrafluoroethylene/perfluoroether copolymer, reinforcing yarns formed of a polyphenylene sulfide, reinforcing yarns formed of a polyether ether ketone, reinforcing yarns formed of a nylon and reinforcing yarns formed of a polypropylene.

9. The dry ion exchange membrane production method according to claim 1, wherein the dry ion exchange membrane is used as an electrolyte membrane contained in a membrane electrode assembly of a water electrolyzer.
